(19) United States
(12) Patent Application Publication
(10) Pub. No.: US 2024/0161724 A1
(43) Pub. Date: May 16, 2024

(54) ACTIVE NOISE CONTROL DEVICE, ACTIVE NOISE CONTROL METHOD, AND NON-TRANSITORY TANGIBLE COMPUTER-READABLE STORAGE MEDIUM

(71) Applicant: HONDA MOTOR CO., LTD.

(72) Inventors: Toshio INOUE, WAKO-SHI, SAITAMA-KEN (JP); Xun WANG, WAKO-SHI, SAITAMA-KEN (JP)

(21) Appl. No.: 18/282,584

(22) PCT Filed: Mar. 26, 2021
(86) PCT No.: PCT/JP2021/012966

§ 371 Date: Sep. 18, 2023

(51) Int. Cl. G10K 11/178

(52) U.S. Cl. CPC G10K 11/17817; G10K 11/17815; G10K 11/17823; G10K 11/17825; G10K 11/17879; G10K 2210/3022; G10K 2210/3026; G10K 2210/3027; G10K 2210/3028; G10K 2210/3055

(57) ABSTRACT

An active noise control device controls a speaker on the basis of an error signal outputted from a detector that has detected, at a control point, a synthesized sound of a noise transmitted from a vibration source and a cancellation sound outputted from the speaker in order to cancel out the noise, and is provided with a control signal generation unit that generates a control signal for controlling the speaker by performing signal processing on a reference signal by a control filter corresponding to an error signal buffered at the end of an input buffer for buffering error signals on a time-series basis.

### TECHNICAL FIELD

The present invention relates to an active noise control device and an active noise control method configured to control a speaker, based on an error signal output from a detector that has detected at a control point a composite sound of noise transmitted from a vibration source and a noise canceling sound output from a speaker in order to cancel out the noise, as well as to a program for causing a computer to execute the active noise control method, and a non-transitory tangible computer-readable storage medium in which the program is stored.

### BACKGROUND ART

In JP 2008-239098 A, a technique is disclosed of generating a basic signal based on a rotational frequency of a propeller shaft, and performing signal processing on the basic signal by an adaptive filter, thereby generating a control signal for controlling a speaker. By the speaker being controlled by the control signal, noise is reduced by outputting a noise canceling sound that cancels the noise output from the speaker. Updating of the adaptive filter is carried out based on an error signal output by a microphone provided in a vehicle, and in addition, a reference signal which is generated by correcting the basic signal by a correction value.

### SUMMARY OF THE INVENTION

In the case that sound information processing is performed in a general purpose terminal such as a smart phone or the like that is driven by a general purpose OS, each of an input signal and an output signal, which are sound information signals, are respectively subjected to buffering in a buffer. Therefore, a delay time from inputting of the input signals until outputting of the output signals corresponding to the input signals is lengthened. In the case that the technique disclosed in JP 2008-239098 A is applied to a general purpose terminal, a concern arises in that the noise reduction performance may become deteriorated due to lengthening of the delay time.

In order to solve the aforementioned problem, the present invention has the object of providing an active noise control device and an active noise control method which are capable of improving the performance of an active noise control, in the case that each of an input signal and an output signal, which are sound information signals, are subjected to buffering in a buffer and thereby sound information processing, as well as providing a program for causing a computer to execute the active noise control method, and a non-transitory tangible computer-readable storage medium in which the program is stored.

A first aspect of the present invention is characterized by an active noise control device configured to control a speaker, based on error signals output from a detector that has detected at a control point a composite sound of noise transmitted from a vibration source and a noise canceling sound output from the speaker in order to cancel out the noise, the active noise control device including an input buffer configured to enable buffering of the error signals in time series, a control filter updating unit configured to adaptively update a control filter, which is an adaptive filter, based on each of the error signals subjected to buffering in the input buffer, a basic signal generation unit configured to generate a basic signal corresponding to a vibration frequency of the vibration source, and a control signal generation unit configured to perform signal processing on the basic signal by the control filter corresponding to one of the error signals subjected to buffering at a last input made to the input buffer, and thereby generate a control signal to control the speaker.

A second aspect of the present invention is characterized by an active noise control device configured to control a speaker, based on error signals output from a detector that has detected at a control point a composite sound of noise transmitted from a vibration source and a noise canceling sound output from the speaker in order to cancel out the noise, the active noise control device including a basic signal generation unit configured to generate a basic signal corresponding to a vibration frequency of the vibration source, a virtual control signal generation unit configured to perform signal processing on the basic signal by a control filter, which is an adaptive filter, to thereby generate a virtual control signal, a first virtual canceling sound signal generation unit configured to perform signal processing on the virtual control signal by a secondary path filter, which is an adaptive filter, to thereby generate a first virtual canceling sound signal, a reference signal generation unit configured to perform signal processing on the basic signal by the secondary path filter, to thereby generate a reference signal, a second virtual canceling sound signal generation unit configured to perform signal processing on the reference signal by the control filter, to thereby generate a second virtual canceling sound signal, a third virtual canceling sound signal generation unit configured to perform signal processing on the reference signal by a differential control filter, to thereby generate a third virtual canceling sound signal, an estimated noise signal generation unit configured to perform signal processing on the basic signal by a primary path filter, which is an adaptive filter, to thereby generate an estimated noise signal, an input buffer configured to enable buffering of the error signals in time series, a first virtual error signal generation unit configured to generate a first virtual error signal, based on each of the error signals subjected to buffering in the input buffer, and the third virtual canceling sound signal, a second virtual error signal generation unit configured to generate a second virtual error signal, based on the first virtual error signal, the first virtual canceling sound signal, and the estimated noise signal, a third virtual error signal generation unit configured to generate a third virtual error signal, based on the second virtual canceling sound signal, and the estimated noise signal, a primary path filter updating unit configured to sequentially and adaptively update the primary path filter, based on the basic signal, and the second virtual error signal, in a manner so that a magnitude of the second virtual error signal becomes minimal, a secondary path filter updating unit configured to sequentially and adaptively update the secondary path filter, based on the virtual control signal, and the second virtual error signal, in a manner so that a magnitude of the second virtual error signal becomes minimal, a control filter updating unit configured to adaptively update the control filter, based on the reference signal, and the third virtual error signal, in a manner so that a magnitude of the third virtual error signal becomes minimal, and a control signal generation unit configured to perform signal processing on the basic signal by the control filter, corresponding to one of the error signals subjected to buffering at a last input made to the input buffer, and thereby generate a control signal to control the speaker.

A third aspect of the present invention is characterized by an active noise control method for controlling a speaker, based on error signals output from a detector that has detected at a control point a composite sound of noise transmitted from a vibration source and a noise canceling sound output from the speaker in order to cancel out the noise, the active noise control method including buffering the error signals in time series, adaptively updating a control filter, which is an adaptive filter, corresponding to each of the error signals subjected to buffering in the input buffer, generating a basic signal corresponding to a vibration frequency of the vibration source, and performing signal processing on the basic signal by the control filter corresponding to one of the error signals subjected to buffering at a last input made to the input buffer, and thereby generating a control signal to control the speaker.

A fourth aspect of the present invention is characterized by a program configured to cause a computer to execute the active noise control method according to the above-described third aspect.

A fifth aspect of the present invention is characterized by a non-transitory tangible computer-readable storage medium in which there is stored a program configured to cause a computer to execute the active noise control method according to the above-described third aspect.

According to the present invention, it is possible to improve the performance of the active noise control.

### BRIEF DESCRIPTION OF THE DRAWINGS

FIG. 1 is a diagram for describing an outline of an active noise control executed in an active noise control device;

FIG. 2 is a control block diagram of an active noise control unit;

FIG. 3 is a diagram for describing an overview of generating a control signal;

FIG. 4 is a flow chart showing the process flow of a control signal generation process performed in the active noise control device;

FIG. 5 is a diagram for describing an outline of an active noise control executed in an active noise control device;

FIG. 6 is a control block diagram of an active noise control unit;

FIG. 7 is a flow chart showing the process flow of a control signal generation process performed in the active noise control device;

FIG. 8 is a graph showing a sonic pressure level versus a vibration frequency;

FIG. 9 is a graph showing a sonic pressure level versus a vibration frequency; and

FIG. 10 is a control block diagram of an active noise control device.

### DESCRIPTION OF THE INVENTION

### First Embodiment

### [Outline of Active Noise Control]

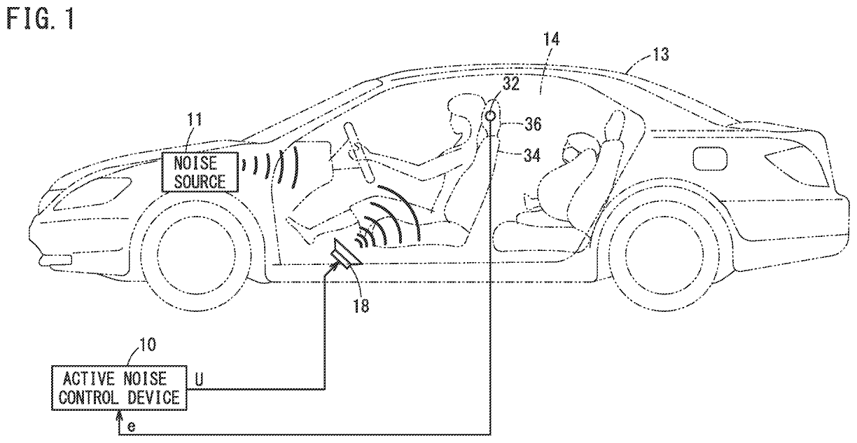

FIG. 1 is a diagram for describing an outline of an active noise control executed in an active noise control device 10.

Noise emitted from a noise source 11 is transmitted into a vehicle compartment 14 of a vehicle 13. The active noise control device 10 according to the present embodiment outputs a canceling sound from a speaker 18 provided inside the vehicle compartment 14, and thereby reduces the sonic pressure of the noise at a control point inside the vehicle compartment 14.

The active noise control device 10 according to the present embodiment, for example, is a terminal (hereinafter referred to as a general purpose terminal) which is driven by a general purpose OS, such as a smart phone or the like. In the present embodiment, by executing an active noise control program, the general purpose terminal in which the active noise control program is installed functions as the active noise control device 10. The general purpose terminal need not necessarily be a mobile terminal. The general purpose terminal may be attached to the vehicle 13, and may function as an infotainment device.

The active noise control device 10 is connected in a wired or wireless manner to the vehicle 13, and acquires error signals e output from a microphone 32. Further, the active noise control device 10 also outputs control signals U for controlling the speaker 18.

According to the present embodiment, the microphone 32 is provided in a headrest 36 of a seat 34 in the vehicle compartment 14 to set the control point near the ear of a vehicle passenger, as shown in FIG. 1. The error signals e are signals that are output from the microphone 32, which has detected a composite sound made up of noise d at the control point and a canceling sound y at the control point.

The active noise control device 10 includes a computation unit and a storage unit, neither of which is illustrated. The computation unit, for example, is constituted by a processor such as a CPU (Central Processing Unit), a GPU (Graphics Processing Unit), or the like.

The computation unit includes a determination unit and a control unit, neither of which is shown. The determination unit and the control unit are realized by programs stored in the storage unit being executed by the computation unit.

Moreover, it should be noted that at least a portion of the determination unit and the control unit may be implemented by an integrated circuit such as an ASIC (Application Specific Integrated Circuit), or a FPGA (Field-Programmable Gate Array). Further, at least a portion of the determination unit and the control unit may be constituted by an electronic circuit including a discrete device.

The storage unit is a non-transitory tangible computer-readable storage medium, and may be constituted by a non-illustrated volatile memory and a non-illustrated non-volatile memory. As the volatile memory, there may be cited, for example, a RAM (Random Access Memory). As the non-volatile memory, there may be cited, for example, a ROM (Read Only Memory), a flash memory, or the like. Data and the like may be stored, for example, in the volatile memory. Programs, tables, maps, and the like are stored, for example, in the non-volatile memory. At least a portion of the storage unit may be provided in the processor, the integrated circuit, or the like, which were described above.

### [Configuration of Active Noise Control Device]

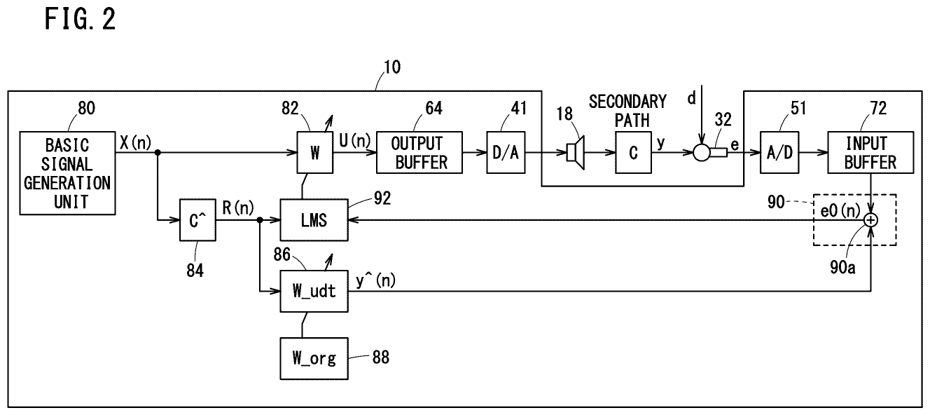

FIG. 2 is a control block diagram of the active noise control device 10. Hereinafter, a sound transmission path from the speaker 18 to the microphone 32 will be referred to as a secondary path, and C will be regarded as the transmission characteristic of the secondary path.

The active noise control device 10 includes an input buffer 72, an output buffer 64, a basic signal generation unit 80, a control signal generation unit 82, a reference signal generation unit 84, a virtual canceling sound signal generation unit 86, a differential control filter updating unit 88, a virtual error signal generation unit 90, and a control filter updating unit 92. The basic signal generation unit 80, the control signal generation unit 82, the reference signal generation unit 84, the virtual canceling sound signal generation unit 86, the differential control filter updating unit 88, the virtual error signal generation unit 90, and the control filter updating unit 92 are realized by executing in the computation unit a program that is stored in the previously mentioned storage unit. The input buffer 72 and the output buffer 64 are implemented by the storage unit.

The input buffer 72 has a buffer size of N, and performs buffering in time series of N individual error signals e(1) to e(N). Among the error signals e(1) to e(N) that are subjected to buffering in the input buffer 72, an error signal e(1) having a buffer number n of “1” is a first error signal subjected to buffering, and an error signal e(N) having a buffer number n of “N” is a last error signal subjected to buffering.

Concerning the error signals e(n) subjected to buffering in the input buffer 72, one of the error signals e(n) in one control period is processed in the active noise control device 10. Hereinafter, the signals and filters processed in the same control period as the control period in which the error signals e(n) are processed, may be expressed using a buffer number n. For example, the control signal processed in the same control period as the control period in which the error signal e(1) is processed, is expressed as U(1), and the control filter is expressed as W(1). More specifically, the control signal U(n) is the control signal corresponding to the error signal e(n), and the control filter W(n) is the control filter corresponding to the error signal e(n).

The error signal e(n) subjected to buffering in the input buffer 72 is a signal obtained by converting an analog signal output by the microphone 32 into a digital signal by an analog/digital converter 51.

The output buffer 64 has a buffer size of N, and performs buffering in time series of N control signals U(1) to U(N) generated by the control signal generation unit 82, which will be described later. When N individual signals U(1) to U(N) are accumulated in the output buffer 64, a digital/analog converter 41 converts the signals into analog signals in order from the control signal U(1), and outputs the signals to the speaker 18.

The basic signal generation unit 80 generates a basic signal X(n) as a noise signal that serves as an object for sonic pressure reduction. Assuming that the number of taps of a later-described adaptive FIR (Finite Impulse Response) filter is M, the basic signal X(n) can be represented by the following vector.

X(n)=[x(n),x(n−1), . . . ,x(n−M+1)]^{T} (1)

The control signal generation unit 82 performs signal processing on the basic signal X(n) by the control filter W(N), and thereby generates the control signal U(n). The control filter W(N) is a control filter corresponding to the error signal e(N) buffered at the last input made to the input buffer 72. In the control signal generation unit 82, an adaptive FIR filter is used as the control filter W(N). Each of respective control filters W(n) that include the control filter W(N) are updated and optimized in the later-described control filter updating unit 92. Moreover, it should be noted that the control filter W(n) can be represented by the following vector.

W(n)=[W0(n),W1(n), . . . ,WM−1(n)]^{T} (2)

Further, the control signal U(n) can be represented by the following vector.

U(n)=[u(n),u(n−1), . . . ,u(n−M+1)]^{T} (3)

An element u(n) of the control signal U(n) can be indicated by the following equation. Hereinafter, “*” in the following equation indicates a convolution operation.

u(n)=W(N)^{T}*X(n) (4)

The reference signal generation unit 84 performs signal processing on the basic signal X(n) by the secondary path filter C\hat{ }, and thereby generates the reference signal R(n). The secondary path filter C\hat{ } is a fixed value that is identified in advance for the transfer characteristic C of the secondary path. The secondary path filter C\hat{ } can be indicated by the following vector.

C\hat{ }=[C0\hat{ },C1\hat{ }, . . . ,CM−1\hat{ }]^{T} (5)

Further, the reference signal R(n) can be represented by the following vector.

R(n)=[r(n),r(n−1), . . . ,r(n−M+1)]^{T} (6)

The element r(n) of the reference signal R(n) can be indicated by the following equation.

r(n)=C\hat{ }^{T}*X(n) (7)

The virtual canceling sound signal generation unit 86 performs signal processing on the reference signal R(n) by the differential control filter W_udt(n), and thereby generates the virtual canceling sound signal y\hat{ }(n). A detailed description will be given later concerning the differential control filter W_udt(n). The virtual canceling sound signal y\hat{ }(n) can be expressed by the following equation.

y\hat{ }(n)=W_udt(n)^{T}*R(n) (8)

The differential control filter updating unit 88 updates the differential control filter W_udt(n). A detailed description will be given later concerning updating of the differential control filter W_udt(n).

The virtual error signal generation unit 90 generates a virtual error signal e0(n) based on the error signal e(n) subjected to buffering in the input buffer 72, and in addition, the virtual canceling sound signal y\hat{ }(n). The virtual error signal generation unit 90 includes an adder 90a. The error signals e(n) and the virtual canceling sound signal y\hat{ }(n) are added in the adder 90a, and thereby the virtual error signal e0(n) is generated.

The control filter updating unit 92 sequentially and adaptively updates the control filter W(n) by an adaptive algorithm (for example, an LMS (Least Mean Square) algorithm), in a manner so that the virtual error signal e0(n) becomes minimal. A detailed description will be given later concerning updating of the control filter W(n).

### [Outline of Generation of Control Signal U(n)]

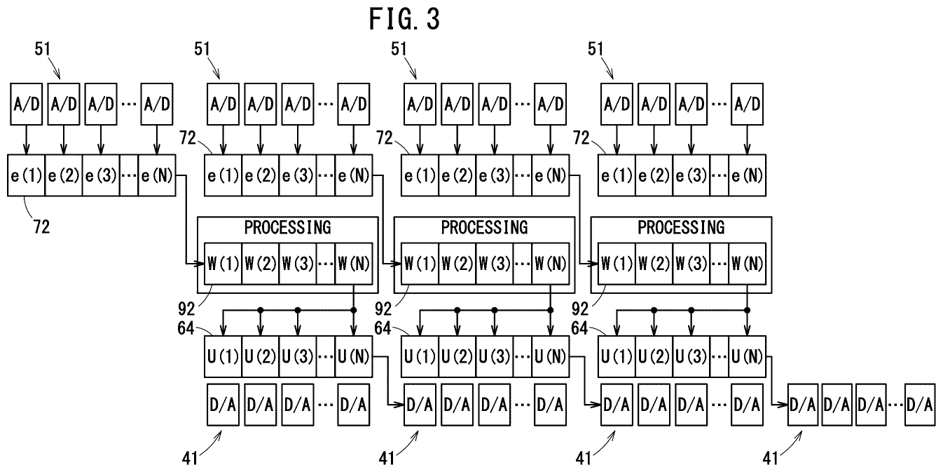

FIG. 3 is a diagram illustrating an outline of generation of the control signal U(n). The active noise control device 10 according to the present embodiment is a terminal which is driven by a general purpose OS of a smart phone or the like. The active noise control device 10 according to the present embodiment samples the error signals e at a sampling frequency (for example, 44.1 [kHz] or 48 [kHz]), and sequentially converts the error signals e into digital signals by the analog/digital converter 51, and subjects them to buffering in the input buffer 72.

When the number of the error signals e(n) subjected to buffering in the input buffer 72 reaches N, a control filter updating unit 76 repeatedly carries out updating of the control filter W(n), based on each of the error signals e(1) to e(N) that were respectively subjected to buffering in the input buffer 72. In addition, a control signal generation unit 62 uses the control filter W(N) that was updated on the basis of the last error signal e(N) subjected to buffering in the input buffer 72, and thereby generates the control signals U(1) to U(N). The generated control signals U(1) to U(N) are subjected to buffering in the output buffer 64. The control signals U(1) to U(N) subjected to buffering in the output buffer 64 are converted into analog signals by the digital/analog converter 41, and are output to the speaker 18.

### [Control Signal Generation Process]

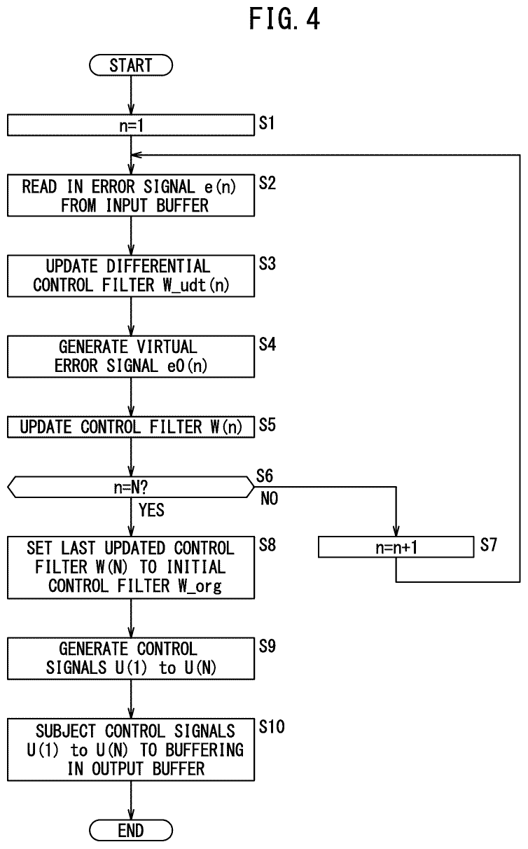

FIG. 4 is a flow chart showing the process flow of a control signal generation process performed in the active noise control device 10. The control signal generation process is executed each time that N individual error signals e(1) to e(N) are subjected to buffering in the input buffer 72.

In step S1, the active noise control device 10 sets the counter n to “1”, whereupon the process transitions to step S2.

In step S2, the active noise control device 10 reads in the error signal e(n) from the input buffer 72, whereupon the process transitions to step S3.

In step S3, the differential control filter updating unit 88 of the active noise control device 10 updates the differential control filter W_udt(n), whereupon the process transitions to step S4. The differential control filter updating unit 88 updates the differential control filter W_udt(n) based on the following equation. Moreover, it should be noted that W(n−1) in the equation indicates the most recent control filter that was updated by the control filter updating unit 92 in step S5 of the previous control period. W_org in the equation is an initial control filter W_org, which will be described later, and W(0)=W_org is brought about.

W_udt(n)=W(n−1)−W_org (9)

In step S4, the virtual error signal generation unit 90 of the active noise control device 10 generates the virtual error signal e0(n), whereupon the process transitions to step S5. The virtual error signal generation unit 90 generates the virtual error signal e0 based on the following equation.

e0(n)=e(n)+y\hat{ }(n)=e(n)+W_udt(n)*R(n) (10)

In step S5, the control filter updating unit 92 of the active noise control device 10 updates the control filter W(n), whereupon the process transitions to step S6. The control filter updating unit 92 updates the control filters W based on the following equation. The term μ_{N} in the equation indicates a step size parameter.

W(n)=W(n−1)−μ_{W}×e0(n)*R(n) (11)

The virtual error signal e0(n) in the above-described equation is obtained from the error signal e(n), and the control filter W(n) can also be updated correspondingly with respect to the error signal e(n).

In step S6, the active noise control device 10 determines whether or not the counter n is “N”. In the case that the counter n is “N”, the process transitions to step S8, and in the case that the counter n is not “N”, the process transitions to step S7.

In step S7, the active noise control device 10 increments the counter n, whereupon the process returns to step S2.

In step S8, the differential control filter updating unit 88 of the active noise control device 10 sets the last updated control filter W(N) (at a time when the counter n=N) to the initial control filter W_org, whereupon the process transitions to step S9. More specifically, each time that the control filter W(N) is updated correspondingly with respect to the error signal e(N) subjected to buffering at the last input made to the input buffer 72, the differential control filter updating unit 88 sets the updated control filter W(N) as the initial control filter W_org.

In step S9, the control signal generation unit 82 of the active noise control device 10 performs signal processing on the basic signals X(1) to X(N) by the control filter W(N), and thereby generates the control signals U(1) to U(N), whereupon the process transitions to step S10.

In step S10, the output buffer 64 of the active noise control device 10 sequentially subjects the control signals U(1) to U(N) generated in the control signal generation unit 62 to buffering, whereupon the control signal generation process is brought to an end.

The processes of steps S2 to S5 are executed one time in each of the control periods, and are repeated N times.

### [Actions and Advantageous Effects]

As noted previously, the active noise control device 10 according to the present embodiment is a general purpose terminal such as a smart phone driven by a general purpose OS. In the case that the sound information process is carried out in such a general purpose terminal, the input signal, which is a sound information signal that is sampled, is temporarily subjected to buffering in the input buffer. When the number of the input signal data which are subjected to buffering in the input buffer reaches a predetermined number, the general purpose terminal performs a process using the input signals that were subjected to buffering, and thereby generates output signals. In addition, the output signals are subjected to buffering temporarily in the output buffer, and when the number of data in the output signals reaches a predetermined number, the output signals that were subjected to buffering in the output buffer are sequentially output. Therefore, in the general purpose terminal, a delay time from inputting of the input signals until outputting of the output signals corresponding to the input signals is lengthened.

On the other hand, by dedicated equipment for the purpose of carrying out the active noise control (hereinafter, referred to as dedicated equipment), sequential processing is performed each time that the input signals are sampled, whereby output signals are generated, and the generated output signals are sequentially output. Therefore, in such dedicated equipment, it is possible to shorten the delay time from inputting of the input signals until outputting of the output signals corresponding to the input signals.

For example, when the sampling frequency is set to 48 [kHz] in the general purpose terminal, and each of the input buffer and the output buffer is set to a size that is capable of buffering on the order of 100 pieces of data, the delay becomes substantially the same as the delay time in the case that sampling is carried out at a sampling frequency of on the order of 500 [Hz] in a dedicated device.

Since, as the delay time becomes longer, the greater the change becomes between an acoustic environment in which the input signal is input and an acoustic environment in which the output signal is output, the performance of the active noise control is degraded.

In the active noise control device 10 according to the present embodiment, although the delay time itself cannot be made shorter, in realizing the active noise control device 10 using a general purpose terminal, the performance of the active noise control can be improved. Specifically, in the active noise control device 10 according to the present embodiment, by the control filter W(N) that was updated on the basis of the last error signal e(N) subjected to buffering in the input buffer 72 and thereby generating the control signals U(1) to U(N), it is possible to improve the performance of the active noise control.

### Second Embodiment

### [Outline of Active Noise Control]

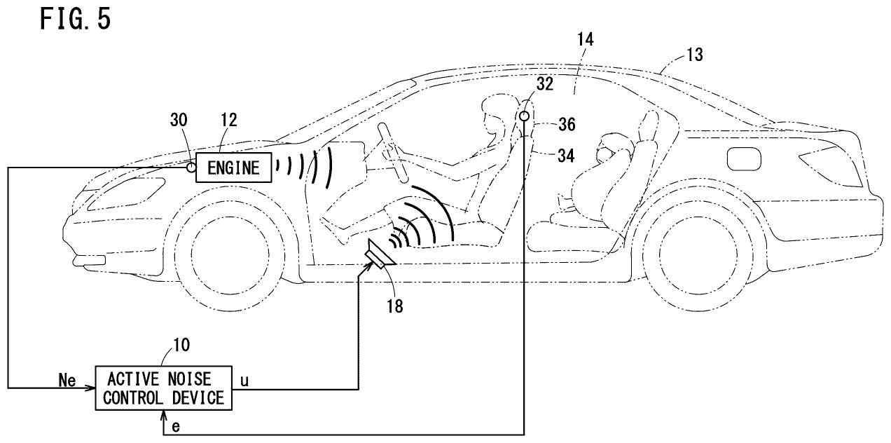

FIG. 5 is a diagram for describing an outline of the active noise control executed in the active noise control device 10.

Accompanying an engine 12 being rotated and the propeller shaft being rotated at a time that the vehicle is traveling, periodic noise referred to as booming engine noise is generated in the vehicle compartment 14 of the vehicle 13. The active noise control device 10 according to the present embodiment causes a canceling sound to be output from the speaker 18 provided inside the vehicle compartment 14, and reduces the sonic pressure of the engine booming noise at the control point inside the vehicle compartment 14.

According to the first embodiment, signal processing is performed using the FIR filter, in order to reduce the sonic pressure of noise inside the vehicle compartment 14 over a wide range of frequencies. On the other hand, according to the present embodiment, the sonic pressure of booming engine noise having a specific vibration frequency f determined by the engine rotation speed Ne is caused to be reduced. Naturally, although signal processing using the FIR filter can be performed in order to cause the sonic pressure of the booming engine sound to be reduced, according to the present embodiment, in order to reduce the load on the computation unit, signal processing in which a notch filter is used is carried out.

The active noise control device 10 is connected in a wired or wireless manner to the vehicle 13, and acquires the engine speed Ne detected by an engine rotational speed sensor 30 and the error signals e output from the microphone 32. Further, the active noise control device 10 outputs control signals u for controlling the speaker 18.

### [Configuration of Active Noise Control Device]

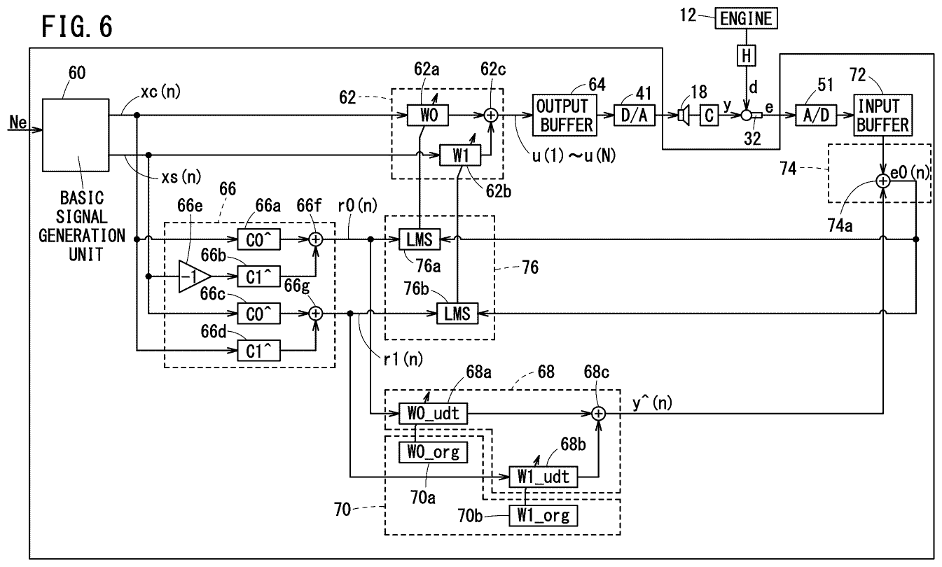

FIG. 6 is a control block diagram of the active noise control device 10. Hereinafter, the transmission path of sound from the engine 12 to the microphone 32 will be referred to as a primary path, and H will be regarded as the transmission characteristic of the primary path. Further, the sound transmission path from the speaker 18 to the microphone 32 will be referred to as a secondary path, and C will be regarded as the transmission characteristic of the secondary path.

The active noise control device 10 includes the input buffer 72, the output buffer 64, a basic signal generation unit 60, the control signal generation unit 62, a reference signal generation unit 66, a virtual canceling sound signal generation unit 68, a differential control filter updating unit 70, a virtual error signal generation unit 74, and the control filter updating unit 76. The basic signal generation unit 60, the control signal generation unit 62, the reference signal generation unit 66, the virtual canceling sound signal generation unit 68, the differential control filter updating unit 70, the virtual error signal generation unit 74, and the control filter updating unit 76 are realized by executing in the computation unit a program that is stored in the storage unit that was described in the first embodiment. The input buffer 72 and the output buffer 64 are implemented by the storage unit.

The input buffer 72 has a buffer size of N, and performs buffering in time series of N individual error signals e(1) to e(N). Among the error signals e(1) to e(N) that are subjected to buffering in the input buffer 72, an error signal e(1) having a buffer number n of “1” is a first error signal subjected to buffering, and an error signal e(N) having a buffer number n of “N” is a last error signal subjected to buffering.

Concerning the error signals e(n) subjected to buffering in the input buffer 72, one of the error signals e(n) in one control period is processed in the active noise control device 10. Hereinafter, the control period in which the error signals e(n) are processed, and the signals and filters processed in the same control period may be expressed using a buffer number n. For example, the control signal processed in the same control period as the control period in which the error signal e(1) is processed, is expressed as u(1), and the control filter is expressed as W(1). More specifically, the control signal u(n) is the control signal corresponding to the error signal e(n), and the control filter W(n) is the control filter corresponding to the error signal e(n).

The error signal e(n) subjected to buffering in the input buffer 72 is a signal obtained by converting an analog signal output by the microphone 32 into a digital signal by the analog/digital converter 51.

The output buffer 64 has a buffer size of N, and performs buffering in time series of N control signals u(1) to u(N) generated by the control signal generation unit 62, which will be described later. When N individual signals u(1) to u(N) are accumulated in the output buffer 64, the digital/analog converter 41 converts the signals into analog signals in order from the control signal u(1), and outputs the signals to the speaker 18.

Based on the engine rotational speed Ne, the basic signal generation unit 60 calculates the vibration frequency f of the engine 12. Further, the basic signal generation unit 60 also generates a basic signal xc(n) (=cos(2π×f×nt)), which is a cosine signal of the vibration frequency f, and in addition, a basic signal xs(n) (=sin(2π×f×nt)), which is a sine signal of the vibration frequency f. In this instance, t indicates the control period.

The control signal generation unit 62 performs signal processing on the basic signal xc(n) and the basic signal xs(n) by the control filter W(N), and thereby generates the control signals u(1) to u(N). In the control signal generation unit 62, an adaptive notch filter (for example, a SAN (Single-frequency Adaptive Notch) filter) is used as the control filter W(N). The control filter W(N) is a control filter that is updated in the control filter updating unit 76, on the basis of the last of the error signals e(N) subjected to buffering in the input buffer 72. The control filter W(N) includes a filter coefficient W0(N) for adjusting the amplitude of the cosine wave component, and a filter coefficient W1(N) for adjusting the amplitude of the sine wave component of the canceling sound output from the speaker 18.

A first control filter 62a has the filter coefficient W0(N). A second control filter 62b has the filter coefficient W1(N). The basic signal xc(n) whose amplitude has been adjusted in the first control filter 62a, and the basic signal xs(n) whose amplitude has been adjusted in the second control filter 62b are added in an adder 62c, and thereby the control signals u(1) to u(N) are generated.

The reference signal generation unit 66 performs signal processing on the basic signal xc(n) and the basic signal xs(n) by the secondary path filter C\hat{ }, and thereby generates the reference signal r0(n) and the reference signal r1(n). The secondary path filter C\hat{ } is a fixed value that is identified in advance for the transfer characteristic C of the secondary path.

The reference signal generation unit 66 includes a first secondary path filter 66a, a second secondary path filter 66b, a third secondary path filter 66c, a fourth secondary path filter 66d, an inverting amplifier 66e, an adder 66f, and an adder 66g.

The first secondary path filter 66a has a filter coefficient C0\hat{ }. The second secondary path filter 66b has a filter coefficient C1\hat{ }. The third secondary path filter 66c has the filter coefficient C0\hat{ }. The fourth secondary path filter 66d has the filter coefficient C1\hat{ }.

The basic signal −xs(n) whose polarity is inverted by the inverting amplifier 66e is input to the second secondary path filter 66b. The basic signal xc(n) whose amplitude has been adjusted in the first secondary path filter 66a, and the basic signal −xs(n) whose amplitude has been adjusted in the second secondary path filter 66b are added in the adder 66f, and thereby the reference signal r0(n) is generated.

The basic signal xs(n) whose amplitude has been adjusted in the third secondary path filter 66c, and the basic signal xc(n) whose amplitude has been adjusted in the fourth secondary path filter 66d are added in the adder 66g, and thereby the reference signal r1(n) is generated.

The virtual canceling sound signal generation unit 68 performs signal processing on the reference signal r0(n) and the reference signal r1(n), using the differential control filter W_udt(n), and thereby generates the virtual canceling sound signal y{circumflex over (()}n). The virtual canceling sound signal generation unit 68 includes a first differential control filter 68a, a second differential control filter 68b, and an adder 68c. The first differential control filter 68a has a filter coefficient W0_udt(n). The second differential control filter 68b has a filter coefficient W1_udt(n).

The reference signal r0(n) whose amplitude has been adjusted in the first differential control filter 68a, and the reference signal r1(n) whose amplitude has been adjusted in the second differential control filter 68b are added in the adder 68c, and thereby the virtual canceling sound signal y\hat{ }(n) is generated.

The differential control filter updating unit 70 updates the differential control filter W_udt(n). The differential control filter updating unit 70 includes a first differential filter coefficient updating unit 70a and a second differential control filter updating unit 70b. The first differential filter coefficient updating unit 70a updates the filter coefficient W0_udt(n). The second differential control filter updating unit 70b updates the filter coefficient W1_udt(n). A detailed description will be given later concerning updating of the filter coefficient W0_udt(n) and the filter coefficient W1_udt(n).

The virtual error signal generation unit 74 generates a virtual error signal e0(n) based on the error signal e(n) subjected to buffering in the input buffer 72, and in addition, the virtual canceling sound signal y\hat{ }(n). The virtual error signal generation unit 74 includes an adder 74a. The error signals e(n) and the virtual canceling sound signal y\hat{ }(n) are added in the adder 74a, and thereby the virtual error signal e0(n) is generated.

Based on the virtual error signal e0(n), the reference signal r0(n), and the reference signal r1(n), the control filter updating unit 76 sequentially and adaptively updates the control filter W(n) using an adaptive algorithm (for example, an LMS (Least Mean Square) algorithm), in a manner so that the virtual error signal e0(n) becomes minimal.

The control filter updating unit 76 includes a first control filter coefficient updating unit 76a and a second control filter coefficient updating unit 76b. The first control filter coefficient updating unit 76a and the second control filter coefficient updating unit 76b update the filter coefficient W0(n) and the filter coefficient W1(n). A detailed description will be given later concerning updating of the filter coefficient W0(n) and the filter coefficient W1(n).

### [Control Signal Generation Process]

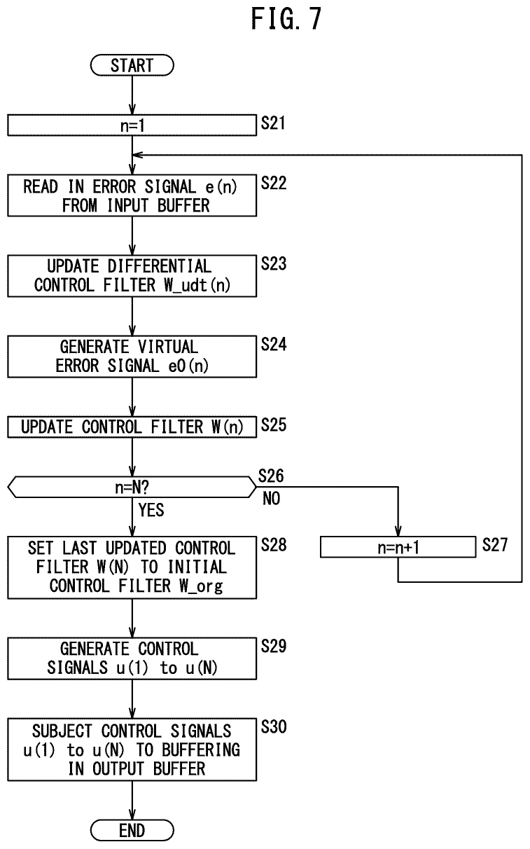

FIG. 7 is a flow chart showing the process flow of a control signal generation process performed in the active noise control device 10. The control signal generation process is executed each time that N individual error signals e(1) to e(N) are subjected to buffering in the input buffer 72.

In step S21, the active noise control device 10 sets the counter n to “1”, whereupon the process transitions to step S22.

In step S22, the active noise control device 10 reads in the error signal e(n) from the input buffer 72, whereupon the process transitions to step S23.

In step S23, the differential control filter updating unit 70 of the active noise control device 10 updates the differential control filter W_udt(n), whereupon the process transitions to step S24. Based on the following equations, the differential control filter updating unit 70 updates the filter coefficient W0_udt and the filter coefficient W1_udt of the differential control filter W_udt(n). Moreover, it should be noted that W0(n−1) and W1(n−1) in the equations indicate filter coefficients of the most recent control filter W(n−1) that was updated by the control filter updating unit 76 in step S25 of the previous control period. Further, W0(0)=W0_org, and W1(0)=W1 org.

W0_udt(n)=W0(n−1)−W0_org

W1_udt(n)=W1(n−1)−W1_org (12)

In step S24, the virtual error signal generation unit 74 of the active noise control device 10 generates the virtual error signal e0, whereupon the process transitions to step S25. The virtual error signal generation unit 74 generates the virtual error signal e0 based on the following equation.

e0(n)=e(n)+y\hat{ }(n)=e(n)+W0_udt(n)×r0(n)+W1_udt(n)×r1(n) (13)

In step S25, the control filter updating unit 76 of the active noise control device 10 updates the control filter W(n), whereupon the process transitions to step S26. The control filter updating unit 76 updates the control filters W based on the following equations. Moreover, the terms μ0_{W} and μ1_{W} in the equations indicate step size parameters.

W0(n)=W0(n−1)−μ0_{W}×e0(n)×r0(n)

W1(n)=W1(n−1)−μ1_{W}×e0(n)×r1(n) (14)

The virtual error signal e0 in the above-described equations is obtained from the error signals, and it can also be said that the control filters W are updated correspondingly with respect to the error signals.

In step S26, the active noise control device 10 determines whether or not the counter n is “N”. In the case that the counter n is “N”, the process transitions to step S28, and in the case that the counter n is not “N”, the process transitions to step S27.

In step S27, the active noise control device 10 increments the counter n, whereupon the process returns to step S2.

In step S28, the differential control filter updating unit 70 of the active noise control device 10 sets the last updated control filter W(n) (at a time when the counter n=N) to the initial control filter W_org, whereupon the process transitions to step S29. More specifically, each time that the control filter W(N) is updated correspondingly with respect to the error signal e(N) subjected to buffering at the last input made to the input buffer 72, the differential control filter updating unit 70 sets the updated control filter W(N) as the initial control filter W_org.

In step S29, the control signal generation unit 62 of the active noise control device 10 performs signal processing on the basic signals xc(1) to xc(N) and the basic signals xs(1) to xs(N) by the control filter W(N), and thereby generates the control signals u(1) to (N), whereupon the process transitions to step S30.

In step S30, the output buffer 64 of the active noise control device 10 sequentially subjects the control signals u(1) to u(N) generated in the control signal generation unit 62 to buffering, whereupon the control signal generation process is brought to an end.

The processes of steps S22 to S25 are executed one time in each of the control periods, and are repeated N times.

### [Actions and Advantageous Effects]

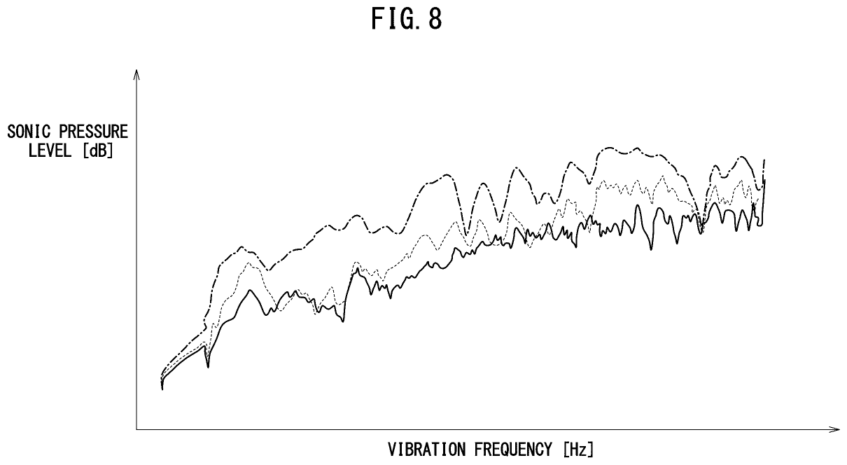

FIG. 8 is a graph showing a sonic pressure level versus a vibration frequency. As in the active noise control device 10 according to the present embodiment, the solid line in FIG. 8 indicates the sonic pressure level for a case in which the speaker 18 is controlled by the control signals u(1) to u(N) which are generated using the control filter W(N). The dashed line in FIG. 8 indicates the sonic pressure level for a case in which the speaker 18 is controlled by the control signals u(1) to u(N) which are generated using the control filters W(1) to W(N) that have been updated respectively based on the error signals e(1) to e(N). The one-dot-dashed line in FIG. 8 indicates the sonic pressure level when the active noise control is not carried out. As shown in FIG. 8, over the entire vibration frequency range, the sonic pressure level indicated by the solid line is generally lower than the sonic pressure level indicated by the dashed line, and the active noise control device 10 according to the present embodiment is capable of realizing an improvement in the performance of the active noise control.

In the active noise control device 10 according to the present embodiment, the basic signal xc and the basic signal xs are processed by the control filter W(N), and thereby the control signals u(1) to u(N) are generated. In particular, the control signals u processed by the control filters W(1) to W(N−1) are not generated. Therefore, the effect of updating the control filters W(1) to W(N−1) does not directly affect the error signals e, and even if updating of the control filters W is carried out using the error signals e, a concern arises in that the appropriate control filters W may not be set. Thus, in order to influence the updating of the control filters W in the control filter updating unit 76, the active noise control device 10 according to the present embodiment generates virtual error signals e0 by adding a virtual canceling sound signal y\hat{ } to the error signals e. Since the virtual canceling sound signal y\hat{ } is obtained based on the differential control filter W_udt, which is defined by the difference between the last of the control filters W and the initial control filter W_org, the virtual canceling sound signal IT\hat{ }can have the effect of exerting an influence on the updating of the control filters W in the control filter updating unit 76.

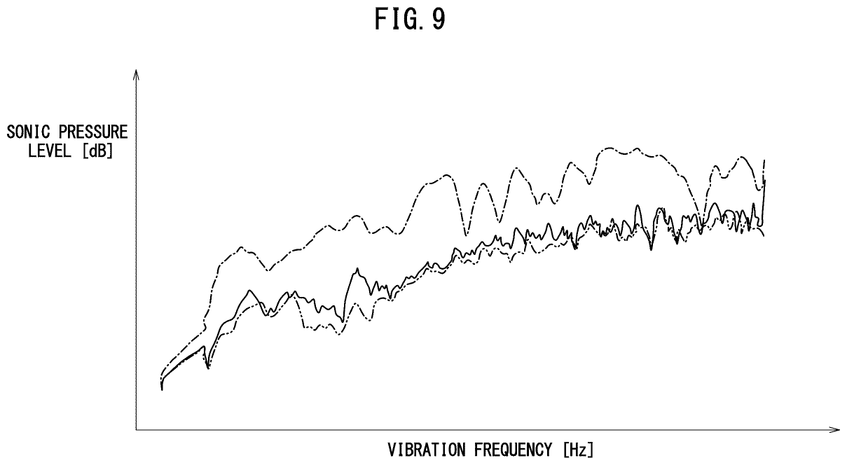

FIG. 9 is a graph showing a sonic pressure level versus a vibration frequency. As in the active noise control device 10 according to the present embodiment, the two-dot-dashed line in FIG. 9 indicates the sonic pressure level for a case in which the speaker 18 is controlled by the control signal u generated using the control filter W which has been updated based on the virtual error signal e0. The solid line in FIG. 9 indicates the sonic pressure level for a case in which the speaker 18 is controlled by the control signal u which is generated using the control filter W which has been updated based on the error signal e. The one-dot-dashed line in FIG. 9 indicates the sonic pressure level when the active noise control is not carried out. Moreover, it should be noted that the sonic pressure levels indicated by the solid line and the one-dot-dashed line in FIG. 9 change in the same way as the sonic pressure level indicated by the solid line and the one-dot-dashed line in FIG. 8, respectively. As shown in FIG. 9, over the entire vibration frequency range, the sonic pressure level indicated by the solid line is generally lower than the sonic pressure level indicated by the dashed line, and the active noise control device 10 according to the present embodiment is capable of further realizing an improvement in the performance of the active noise control.

### Third Embodiment

In the active noise control device 10 according to the second embodiment, a fixed value, which is identified in advance for the transfer characteristic C of the secondary path, is used as the secondary path filter C\hat{ }. In the active noise control device 10 according to the present embodiment, identification of the secondary path filter C\hat{ } is also performed in the active noise control device 10.

### [Configuration of Active Noise Control Device]

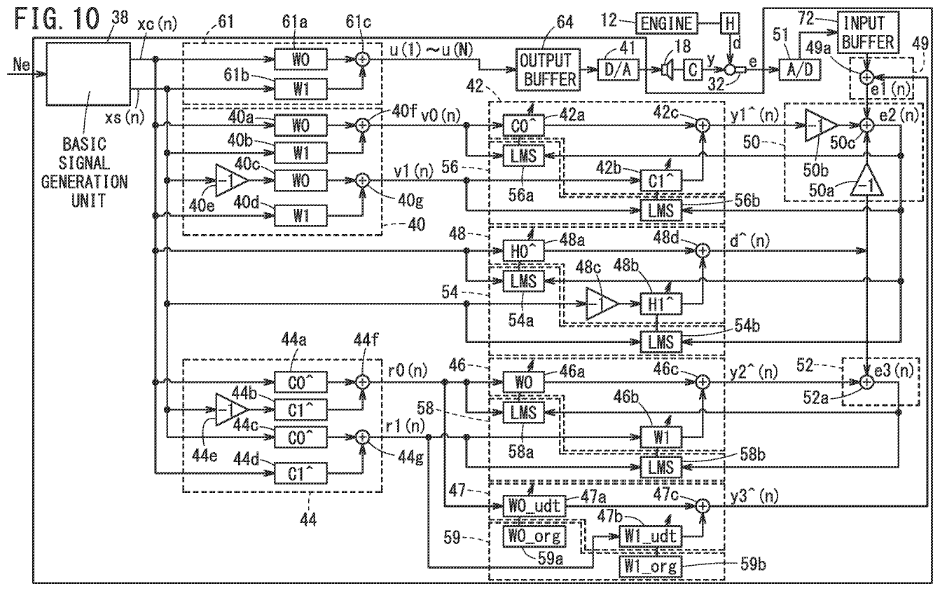

FIG. 10 is a control block diagram of the active noise control device 10. The active noise control device 10 includes the input buffer 72, the output buffer 64, a basic signal generation unit 38, a virtual control signal generation unit 40, a first virtual canceling sound signal generation unit 42, a reference signal generation unit 44, a second virtual canceling sound signal generation unit 46, a third virtual canceling sound signal generation unit 47, an estimated noise signal generation unit 48, a first virtual error signal generation unit 49, a second virtual error signal generation unit 50, a third virtual error signal generation unit 52, a primary path filter updating unit 54, a secondary path filter updating unit 56, a control filter updating unit 58, a differential control filter updating unit 59, and a control signal generation unit 61.

The basic signal generation unit 38, the virtual control signal generation unit 40, the first virtual canceling sound signal generation unit 42, the reference signal generation unit 44, the second virtual canceling sound signal generation unit 46, the third virtual canceling sound signal generation unit 47, the estimated noise signal generation unit 48, the first virtual error signal generation unit 49, the second virtual error signal generation unit 50, the third virtual error signal generation unit 52, the primary path filter updating unit 54, the secondary path filter updating unit 56, the control filter updating unit 58, the differential control filter updating unit 59, and the control signal generation unit 61 are realized by executing in the computation unit a program that is stored in the previously mentioned storage unit. The input buffer 72 and the output buffer 64 are implemented by the storage unit.

The input buffer 72 has a buffer size of N, and performs buffering in time series of N individual error signals e(1) to e(N). Among the error signals e(1) to e(N) that are subjected to buffering in the input buffer 72, an error signal e(1) having a buffer number n of “1” is a first error signal subjected to buffering, and an error signal e(N) having a buffer number n of “N” is a last error signal subjected to buffering.

Concerning the error signals e(n) subjected to buffering in the input buffer 72, one of the error signals e(n) in one control period is processed in the active noise control device 10. Hereinafter, the control period in which the error signals e(n) are processed, and the signals and filters processed in the same control period may be expressed using a buffer number n. For example, the control signal processed in the same control period as the control period in which the error signal e(1) is processed, is expressed as u(1), and the control filter is expressed as W(1). More specifically, the control signal u(n) is the control signal corresponding to the error signal e(n), and the control filter W(n) is the control filter corresponding to the error signal e(n).

The error signal e(n) subjected to buffering in the input buffer 72 is a signal obtained by converting an analog signal output by the microphone 32 into a digital signal by the analog/digital converter 51.

The output buffer 64 has a buffer size of N, and performs buffering in time series of N control signals u(1) to u(N) generated by the control signal generation unit 61, which will be described later. When N individual signals u(1) to u(N) are accumulated in the output buffer 64, the digital/analog converter 41 converts the signals into analog signals in order from the control signal u(1), and outputs the signals to the speaker 18.

Based on the engine rotational speed Ne, the basic signal generation unit 38 calculates the vibration frequency f of the engine 12. Further, the basic signal generation unit 38 unit also generates a basic signal xc(n) (=cos(2π×f×nt)), which is a cosine signal of the vibration frequency f, and in addition, a basic signal xs(n) (=sin (2π×f×nt)), which is a sine signal of the vibration frequency f. In this instance, t indicates the control period.

The virtual control signal generation unit 40 performs signal processing on the basic signal xc(n) and the basic signal xs(n) using the control filter W(n), and thereby generates a virtual control signal v0(n) and a virtual control signal v1(n).

In the virtual control signal generation unit 40, an adaptive notch filter (for example, a SAN (Single-frequency Adaptive Notch) filter) is used as the control filter W(n). The control filter W(n) is updated and optimized in the later-described control filter updating unit 58. The control filter W(n) includes a filter coefficient W0(n) for adjusting the amplitude of the cosine wave component, and a filter coefficient W1(n) for adjusting the amplitude of the sine wave component, of the canceling sound output from the speaker 18.

The virtual control signal generation unit 40 includes a first control filter 40a, a second control filter 40b, a third control filter 40c, a fourth control filter 40d, an inverting amplifier 40e, an adder 40f, and an adder 40g.

The first control filter 40a has the filter coefficient W0(n). The second control filter 40b has the filter coefficient W1(n). The third control filter 40c has the filter coefficient W0(n). The fourth control filter 40d has the filter coefficient W1(n).

The basic signal xc(n) whose amplitude has been adjusted in the first control filter 40a, and the basic signal xs(n) whose amplitude has been adjusted in the second control filter 40b are added in the adder 40f, and thereby the virtual control signal v0(n) is generated.

The basic signal −xs(n) whose polarity is inverted by the inverting amplifier 40e is input to the third control filter 40c. The basic signal −xs(n) whose amplitude has been adjusted in the third control filter 40c, and the basic signal xc(n) whose amplitude has been adjusted in the fourth control filter 40d are added in the adder 40g, and thereby the virtual control signal v1(n) is generated.

In the first virtual canceling sound signal generation unit 42, which will be described next, the virtual control signal v0(n) is used as a real component, and the virtual control signal v1(n) is used as an imaginary component.

The first virtual canceling sound signal generation unit 42 performs signal processing on a virtual control signal v0 and a virtual control signal v1(n) by a secondary path filter C\hat{ }(n), and thereby generates a first virtual canceling sound signal y1\hat{ }(n).

In the first virtual canceling sound signal generation unit 42, an adaptive notch filter (for example, a SAN filter) is used as a secondary path filter C\hat{ }(n). By being updated in the secondary path filter updating unit 56, which will be described later, the secondary path filter C\hat{ }(n) converges on the sound transfer characteristic C in the secondary path. The secondary path filter C\hat{ }(n) is expressed by using a filter coefficient C0\hat{ }(n) and a filter coefficient C1\hat{ }(n) in the equation: C\hat{ }(n)=C0\hat{ }(n)+iC1\hat{ }(n). Moreover, it should be noted that i indicates an imaginary number.

The first virtual canceling sound signal generation unit 42 includes a first secondary path filter 42a, a second secondary path filter 42b, and an adder 42c.

The first secondary path filter 42a has the filter coefficient C0\hat{ }(n). The second secondary path filter 42b has the filter coefficient C1\hat{ }(n). The virtual control signal v0(n) whose amplitude has been adjusted in the first secondary path filter 42a, and the virtual control signal v1(n) whose amplitude has been adjusted in the second secondary path filter 42b are added in the adder 42c, and thereby the first virtual canceling sound signal y1\hat{ }(n) is generated.

The reference signal generation unit 44 performs signal processing on the basic signal xc(n) and the basic signal xs(n) by the secondary path filter C\hat{ }(n), and thereby generates the reference signal r0(n) and the reference signal r1(n).

The reference signal generation unit 44 includes a third secondary path filter 44a, a fourth secondary path filter 44b, a fifth secondary path filter 44c, a sixth secondary path filter 44d, an inverting amplifier 44e, an adder 44f, and an adder 44g.

The third secondary path filter 44a has the filter coefficient C0\hat{ }(n). The fourth secondary path filter 44b has the filter coefficient C1\hat{ }(n). The fifth secondary path filter 44c has the filter coefficient C0\hat{ }(n). The sixth secondary path filter 44d has the filter coefficient C1\hat{ }(n).

The basic signal −xs(n) whose polarity is inverted by the inverting amplifier 44e is input to the fourth secondary path filter 44b. The basic signal xc(n) whose amplitude has been adjusted in the third secondary path filter 44a, and the basic signal −xs(n) whose amplitude has been adjusted in the fourth secondary path filter 44b are added in the adder 44f, and thereby the reference signal r0(n) is generated.

The basic signal xs(n) whose amplitude has been adjusted in the fifth secondary path filter 44c, and the basic signal xc(n) whose amplitude has been adjusted in the sixth secondary path filter 44d are added in the adder 44g, and thereby the reference signal r1(n) is generated.

The second virtual canceling sound signal generation unit 46 performs signal processing on the reference signal r0(n) and the reference signal r1(n) by the control filter W(n), and thereby generates the second virtual canceling sound signal y2\hat{ }(n). The second virtual canceling sound signal generating unit 46 includes a fifth control filter 46a, a sixth control filter 46b, and an adder 46c.

The reference signal r0(n) whose amplitude has been adjusted in the fifth control filter 46a, and the reference signal r1(n) whose amplitude has been adjusted in the sixth control filter 46b are added in the adder 46c, and thereby the second virtual canceling sound signal y2\hat{ }(n) is generated.

The third virtual canceling sound signal generation unit 47 performs signal processing on the reference signal r0(n) and the reference signal r1(n) by the differential control filter W_udt(n), and thereby generates the third virtual canceling sound signal y3\hat{ }(n). The third virtual canceling sound signal generation unit 47 includes a first differential control filter 47a, a second differential control filter 47b, and an adder 47c. The first differential control filter 47a has a filter coefficient W0_udt(n). The second differential control filter 47b has a filter coefficient W1_udt(n).

The reference signal r0(n) whose amplitude has been adjusted in the first differential control filter 47a, and the reference signal r1(n) whose amplitude has been adjusted in the second differential control filter 47b are added in the adder 47c, and thereby the third virtual canceling sound signal y3\hat{ }(n) is generated.

The estimated noise signal generation unit 48 performs signal processing on the basic signal xc(n) and the basic signal xs(n) by the primary path filter H\hat{ }(n), and thereby generates an estimated noise signal d\hat{ }(n). The estimated noise signal generation unit 48 uses an adaptive notch filter (for example, a SAN filter) as the primary path filter H\hat{ }(n). By being updated in the primary path filter updating unit 54, which will be described later, the primary path filter H\hat{ } converges on the sound transfer characteristic H in the primary path. The primary path filter H\hat{ }(n) is expressed by using the filter coefficient H0\hat{ }(n) and the filter coefficient H1\hat{ }(n) in the equation: H\hat{ }(n)=H0\hat{ }(n)+iH1\hat{ }(n). Moreover, it should be noted that i indicates an imaginary number.

The estimated noise signal generation unit 48 includes a first primary path filter 48a, a second primary path filter 48b, an inverting amplifier 48c, and an adder 48d. The first primary path filter 48a has the filter coefficient H0\hat{ }(n). The second primary path filter 48b has the filter coefficient H1\hat{ }(n).

The basic signal −xs(n) whose polarity is inverted by the inverting amplifier 48c is input to the second primary path filter 48b. The basic signal xc(n) whose amplitude has been adjusted in the first primary path filter 48a, and the basic signal −xs(n) whose amplitude has been adjusted in the second primary path filter 48b are added in the adder 48d, and thereby the estimated noise signal d\hat{ }(n) is generated.

The first virtual error signal generation unit 49 generates a first virtual error signal e1(n) based on the error signal e(n) subjected to buffering in the input buffer 72, and in addition, the third virtual canceling sound signal y3\hat{ }(n). The first virtual error signal generation unit 49 includes an adder 49a. The error signals e and the third virtual canceling sound signal y3\hat{ }(n) are added in the adder 49a, and thereby the first virtual error signal e1(n) is generated.

The second virtual error signal generation unit 50 generates a second virtual error signal e2(n) based on the first virtual error signal e1(n), the estimated noise signal d\hat{ }(n), and the first virtual canceling sound signal y1\hat{ }(n). The second virtual error signal generation unit 50 includes an inverting amplifier 50a, an inverting amplifier 50b, and an adder 50c.

The first virtual error signal e1(n), the estimated noise signal −d\hat{ }(n) whose polarity is inverted by the inverting amplifier 50a, and the first virtual error signal −y1\hat{ }(n) whose polarity is inverted by the inverting amplifier 50b are added in the adder 50c, whereby the second virtual error signal e2(n) is generated.

The third virtual error signal generation unit 52 generates a third virtual error signal e3(n) based on the estimated noise signal d\hat{ }(n) and the second virtual canceling sound signal y2\hat{ }(n). The third virtual error signal generation unit 52 includes an adder 52a. The estimated noise signal d\hat{ }(n) and the second virtual canceling sound signal y2\hat{ }(n) are added in the adder 52a, and thereby the third virtual error signal e3(n) is generated.

Based on the second virtual error signal e2(n), the basic signal xc(n), and the basic signal xs(n), the primary path filter updating unit 54 sequentially and adaptively updates the primary path filter H\hat{ }(n) using an adaptive algorithm (for example, an LMS (Least Mean Square) algorithm), in a manner so that the second virtual error signal e2(n) becomes minimal.

The primary path filter updating unit 54 includes a first primary path filter coefficient updating unit 54a and a second primary path filter coefficient updating unit 54b. Based on the following equation, the first primary path filter coefficient updating unit 54a and the second primary path filter coefficient updating unit 54b update the filter coefficient H0\hat{ }(n) and the filter coefficient H1\hat{ }(n). The terms μ0_{H} and μ1_{H} in the equations indicate step size parameters.

H0\hat{ }(n)=H0\hat{ }(n−1)−μ0_{H}×e2(n)×xc(n)

H1\hat{ }(n)=H1\hat{ }(n−1)−μ1_{H}×e2(n)×xs(n) (15)

Based on the second virtual error signal e2(n), the virtual control signal v0(n), and the virtual control signal v1(n), the secondary path filter updating unit 56 sequentially and adaptively updates the secondary path filter C\hat{ } using an adaptive algorithm (for example, an LMS algorithm), in a manner so that the second virtual error signal e2(n) becomes minimal.

The secondary path filter updating unit 56 includes a first secondary path filter coefficient updating unit 56a and a second secondary path filter coefficient updating unit 56b. Based on the following equations, the first secondary path filter coefficient updating unit 56a and the second secondary path filter coefficient updating unit 56b update the filter coefficient C0\hat{ }(n) and the filter coefficient C1\hat{ }(n). The terms μ0_{C} and μ1_{C} in the equation indicate step size parameters.

C0\hat{ }(n)=C0\hat{ }(n−1)−μ0_{C}×e2(n)×v0(n)

C1\hat{ }(n)=C1\hat{ }(n−1)−μ1_{C}×e2(n)×v1(n) (16)

Based on the third virtual error signal e3(n), the reference signal r0(n), and the reference signal r1(n), the control filter updating unit 58 sequentially and adaptively updates the control filter W using an adaptive algorithm (for example, an LMS algorithm), in a manner so that the third virtual error signal e3(n) becomes minimal.

The control filter updating unit 58 includes a first control filter coefficient updating unit 58a and a second control filter coefficient updating unit 58b. Based on the following equations, the first control filter coefficient updating unit 58a and the second control filter coefficient updating unit 58b update the filter coefficient W0(n) and the filter coefficient W1(n). The terms μ0_{W} and μ1_{W} in the equations indicate step size parameters. Moreover, it should be noted that the terms W0(n−1) and W1(n−1) in the equations indicate filter coefficients of the control filter W(n−1) that was previously updated in the control filter updating unit 76. Further, W0(0)=W0_org, and W1(0)=W1 org.

W0(n)=W0(n−1)−μ0_{W}×e3(n)×r0(n)

W1(n)=W1(n−1)−μ1_{W}×e3(n)×r1(n) (17)

The differential control filter updating unit 59 updates the differential control filter W_udt(n). The differential control filter updating unit 59 includes a first differential filter coefficient updating unit 59a and a second differential control filter updating unit 59b. Based on the following equation, the first differential filter coefficient updating unit 59a and the second differential control filter updating unit 59b update the filter coefficient W0_udt(n) and the filter coefficient W1_udt(n). Moreover, it should be noted that the terms W0(n−1) and W1(n−1) in the equation indicate filter coefficients of the control filter W(n−1) that was previously updated in the control filter updating unit 76. Further, W0(0)=W0_org, and W1(0)=W1 org.

W0_udt(n)=W0(n−1)−W0_org

W1_udt(n)=W1(n−1)−W1_org (18)

In this instance, the terms W0 org and W1 org are the filter coefficients W0(N) and W1(N) of the control filter W(N) corresponding to the last of the error signals e(N) that was previously subjected to buffering in the input buffer 72.

The control signal generation unit 61 performs signal processing on the basic signals xc(1) to xc(N) and the basic signals xs(1) to xs(N) by the control filter W(N), and thereby generates the control signals u(1) to u(N). The control filter W(N) is a control filter that is updated in the control filter updating unit 58, on the basis of the last of the error signals e(N) subjected to buffering in the input buffer 72. The control filter W(N) includes a filter coefficient W0(N) for adjusting the amplitude of the cosine wave component, and a filter coefficient W1(N) for adjusting the amplitude of the sine wave component, of the canceling sound output from the speaker 18.

The control signal generation unit 61 includes a first control filter 61a, a second control filter 61b, and an adder 61c.

The first control filter 61a has the filter coefficient W0(N). The second control filter 61b has the filter coefficient W1(N). The basic signal xc(n) whose amplitude has been adjusted in the first control filter 61a, and the basic signal xs(n) whose amplitude has been adjusted in the second control filter 61b are added in the adder 61c, and thereby the control signals u(1) to u(N) are generated.

### [Actions and Advantageous Effects]

In the active noise control device 10, the secondary path filter C\hat{ }(n) is updated by the secondary path filter updating unit 56. In accordance with this feature, for example, in the case that the position of the microphone 32 has been changed or the like, at a time when the transfer characteristic C of the secondary path is changed, the secondary path filter C\hat{ }can be made to follow along with the change in the transfer characteristic C. Therefore, the active noise control device 10 can maintain the performance of the active noise control, even in the case that the transfer characteristic C is changed.

### Technical Concepts Obtained from the Embodiments

A description will be stated below concerning the technical concepts that are capable of being grasped from the above-described embodiments.

In the active noise control device (10) configured to control the speaker (18), based on the error signals output from the detector (32) that has detected at the control point the composite sound of noise transmitted from the vibration source and the noise canceling sound output from the speaker in order to cancel out the noise, the active noise control device includes the input buffer (72) configured to enable buffering of the error signals in time series, the control filter updating unit (76, 92) configured to adaptively update the control filter, which is an adaptive filter, based on each of the error signals subjected to buffering in the input buffer, the basic signal generation unit (60, 80) configured to generate the basic signal corresponding to the vibration frequency of the vibration source, and the control signal generation unit (62, 82) configured to perform signal processing on the basic signal by the control filter corresponding to one of the error signals subjected to buffering at the last input made to the input buffer, and thereby generate the control signal to control the speaker.

In the above-described active noise control device, there may further be provided the reference signal generation unit (66, 84) configured to perform signal processing on the basic signal by the secondary path filter, to thereby generate the reference signal, the virtual canceling sound signal generation unit (68, 86) configured to perform signal processing on the reference signal by the differential control filter, to thereby generate the virtual canceling sound signal, the virtual error signal generation unit (74, 90) configured to generate the virtual error signal, based on each of the error signals subjected to buffering in the input buffer, and the virtual canceling sound signal, the differential control filter updating unit (70, 88) configured to set the control filter as an initial control filter, each time that the control filter corresponding to one of the error signals subjected to buffering at the last input made to the input buffer is updated, and to set in the differential control filter the difference between the control filter and the initial control filter, each time that the control filter is updated in the control filter updating unit, wherein the control filter updating unit sequentially and adaptively updates the control filter, based on the reference signal, and the virtual error signal, in a manner so that the magnitude of the virtual error signal becomes minimal.

In the active noise control device (10) configured to control the speaker (18), based on the error signals output from the detector (32) that has detected at the control point the composite sound of noise transmitted from the vibration source and the noise canceling sound output from the speaker in order to cancel out the noise, the active noise control device includes the basic signal generation unit (38) configured to generate the basic signal corresponding to the vibration frequency of the vibration source, the virtual control signal generation unit (40) configured to perform signal processing on the basic signal by the control filter, which is an adaptive filter, to thereby generate the virtual control signal, the first virtual canceling sound signal generation unit (42) configured to perform signal processing on the virtual control signal by the secondary path filter, which is an adaptive filter, to thereby generate the first virtual canceling sound signal, the reference signal generation unit (44) configured to perform signal processing on the basic signal by the secondary path filter, to thereby generate the reference signal, the second virtual canceling sound signal generation unit (46) configured to perform signal processing on the reference signal by the control filter, to thereby generate the second virtual canceling sound signal, the third virtual canceling sound signal generation unit (47) configured to perform signal processing on the reference signal by the differential control filter, to thereby generate the third virtual canceling sound signal, the estimated noise signal generation unit (48) configured to perform signal processing on the basic signal by the primary path filter, which is an adaptive filter, to thereby generate the estimated noise signal, the input buffer (72) configured to enable buffering of the error signals in time series, the first virtual error signal generation unit (49) configured to generate the first virtual error signal, based on each of the error signals subjected to buffering in the input buffer, and the third virtual canceling sound signal, the second virtual error signal generation unit (50) configured to generate the second virtual error signal, based on the first virtual error signal, the first virtual canceling sound signal, and the estimated noise signal, the third virtual error signal generation unit (52) configured to generate the third virtual error signal, based on the second virtual canceling sound signal, and the estimated noise signal, the primary path filter updating unit (54) configured to sequentially and adaptively update the primary path filter, based on the basic signal, and the second virtual error signal, in a manner so that the magnitude of the second virtual error signal becomes minimal, the secondary path filter updating unit (56) configured to sequentially and adaptively update the secondary path filter, based on the virtual control signal, and the second virtual error signal, in a manner so that the magnitude of the second virtual error signal becomes minimal, the control filter updating unit (58) configured to adaptively update the control filter, based on the reference signal, and the third virtual error signal, in a manner so that the magnitude of the third virtual error signal becomes minimal, and the control signal generation unit (61) configured to perform signal processing on the basic signal by the control filter, corresponding to one of the error signals subjected to buffering at the last input made to the input buffer, and thereby generate the control signal to control the speaker.

In the active noise control method for controlling the speaker, based on the error signals output from the detector that has detected at the control point the composite sound of the noise transmitted from the vibration source and the noise canceling sound output from the speaker in order to cancel out the noise, the active noise control method includes buffering the error signals in time series, adaptively updating the control filter, which is an adaptive filter, based on each of the error signals subjected to buffering in the input buffer, generating the basic signal corresponding to the vibration frequency of the vibration source, and performing signal processing on the basic signal by the control filter corresponding to one of the error signals subjected to buffering at the last input made to the input buffer, and thereby generating the control signal to control the speaker.

The program serves as a program configured to cause the computer to execute the above-described active noise control method.

The non-transitory tangible computer-readable storage medium stores the program configured to cause the computer to execute the above-described active noise control method.

### REFERENCE SIGNS LIST

10: active noise control device
18: speaker
32: microphone (detector)
38, 60, 80: basic signal generation unit
40: virtual control signal generation unit
42: first virtual canceling sound signal generation unit
44, 66, 84: reference signal generation unit
46: second virtual canceling sound signal generation unit
48: estimated noise signal generation unit
58, 76, 92: control filter updating unit
59, 70, 88: differential control filter updating unit
61, 62, 82: control signal generation unit
68: virtual canceling sound signal generation unit
72: input buffer
74: virtual error signal generation unit

1. An active noise control device comprising one or more processors that execute computer-executable instructions stored in a memory, wherein the one or more processors execute the computer-executable instructions to cause the active noise control device to:
enable buffering of error signals in time series in an input buffer, the error signals being output from a detector that has detected at a control point a composite sound of noise transmitted from a vibration source and a noise canceling sound output from a speaker in order to cancel out the noise;
adaptively update a control filter, which is an adaptive filter, correspondingly with respect to each of the error signals subjected to buffering in the input buffer;
generate a basic signal corresponding to a vibration frequency of the vibration source; and
perform signal processing on the basic signal by the control filter updated correspondingly with respect to one of the error signals subjected to buffering at a last input made to the input buffer, and thereby generate a control signal to control the speaker.

2. The active noise control device according to claim 1, wherein the one or more processors execute the computer-executable instructions to cause the active noise control device to:
perform signal processing on the basic signal by a secondary path filter, to thereby generate a reference signal;
perform signal processing on the reference signal by a differential control filter, to thereby generate a virtual canceling sound signal;
generate a virtual error signal, based on the generated virtual canceling sound signal and each of the error signals subjected to buffering in the input buffer;
sequentially and adaptively update the control filter, correspondingly with respect to the reference signal and the virtual error signal, in a manner so that a magnitude of the virtual error signal becomes minimal;
set the control filter as an initial control filter, the control filter being updated correspondingly with respect to the virtual error signal generated from one of the error signals subjected to buffering at the last input made to the input buffer; and
set in the differential control filter a difference between the control filter and the initial control filter, each time that the control filter is updated.

3. An active noise control device comprising one or more processors that execute computer-executable instructions stored in a memory, wherein the one or more processors execute the computer-executable instructions to cause the active noise control device to:
generate a basic signal corresponding to a vibration frequency of a vibration source;
perform signal processing on the basic signal by a control filter, which is an adaptive filter, to thereby generate a virtual control signal;
perform signal processing on the virtual control signal by a secondary path filter, which is an adaptive filter, to thereby generate a first virtual canceling sound signal;
perform signal processing on the basic signal by the secondary path filter, to thereby generate a reference signal;
perform signal processing on the reference signal by the control filter, to thereby generate a second virtual canceling sound signal;
perform signal processing on the reference signal by a differential control filter, to thereby generate a third virtual canceling sound signal;
perform signal processing on the basic signal by a primary path filter, which is an adaptive filter, to thereby generate an estimated noise signal;
enable buffering of error signals in time series in an input buffer, the error signals being output from a detector that has detected at a control point a composite sound of noise transmitted from the vibration source and a noise canceling sound output from a speaker in order to cancel out the noise;
generate a first virtual error signal, based on the third virtual canceling sound signal and each of the error signals subjected to buffering in the input buffer;
generate a second virtual error signal, based on the first virtual error signal, the first virtual canceling sound signal, and the estimated noise signal;
generate a third virtual error signal, based on the second virtual canceling sound signal, and the estimated noise signal;
sequentially and adaptively update the primary path filter, based on the basic signal, and the second virtual error signal, in a manner so that a magnitude of the second virtual error signal becomes minimal;
sequentially and adaptively update the secondary path filter, based on the virtual control signal, and the second virtual error signal, in a manner so that a magnitude of the second virtual error signal becomes minimal;
adaptively update the control filter, based on the reference signal, and the third virtual error signal, in a manner so that a magnitude of the third virtual error signal becomes minimal; and
perform signal processing on the basic signal by the control filter, corresponding to one of the error signals subjected to buffering at a last input made to the input buffer, and thereby generate a control signal to control the speaker.

4. An active noise control method for controlling a speaker, based on error signals output from a detector that has detected at a control point a composite sound of noise transmitted from a vibration source and a noise canceling sound output from the speaker in order to cancel out the noise, the active noise control method comprising:
buffering the error signals in time series;
adaptively updating a control filter, which is an adaptive filter, based on each of the error signals subjected to buffering;
generating a basic signal corresponding to a vibration frequency of the vibration source; and
performing signal processing on the basic signal by the control filter corresponding to one of the error signals subjected to buffering at a last input made to the input buffer, and thereby generating a control signal to control the speaker.

5. (canceled)

6. A non-transitory tangible computer-readable storage medium storing a program configured to cause a computer to execute the active noise control method according to claim 4.
